(19) United States
(12) Patent Application Publication
(10) Pub. No.: US 2026/0356159 A1
(43) Pub. Date: Nov. 12, 2026

(54) METHOD AND APPARATUS FOR SIMULATING EXTERNAL TEMPERATURE OF VEHICLE, ELECTRONIC DEVICE AND VEHICLE

(71) Applicant: CHONGQING CHANGAN AUTOMOBILE CO., LTD., Chongqing (CN)

(72) Inventors: Rui ZHANG, Chongqing (CN); Guang LI, Chongqing (CN); Chunjian LU, Chongqing (CN)

(73) Assignee: CHONGQING CHANGAN AUTOMOBILE CO., LTD., Chongqing (CN)

(21) Appl. No.: 19/377,014

(22) Filed: Nov. 2, 2025

Related U.S. Application Data
(63) Continuation of application No. PCT/CN2025/122746, filed on Sep. 19, 2025.

(30) Foreign Application Priority Data
May 8, 2025 (CN) 202510585253.8

(51) Int. Cl. B60H 1/00; B60H 1/32

(52) U.S. Cl. CPC B60H 1/00792; B60H 1/00807; B60H 1/32; B60H 2001/3238

(57) ABSTRACT

Provided are method and apparatus for simulating an external temperature of a vehicle, an electronic device and a vehicle. The vehicle is provided with at least one sensor and at least one part, and the method includes: acquiring sensor data collected by the sensor and a component state of the part; acquiring a memorial external temperature of the vehicle obtained by a previous simulation; acquiring at least one temperature range interval of the vehicle, where each temperature range interval has a corresponding processing logic; taking a minimum value among the sensor temperatures as a target temperature; taking a temperature range interval in which a difference between the memorial external temperature and the target temperature falls as a target temperature range interval; and simulating the external temperature of the vehicle according to the processing logic corresponding to the target temperature range interval, the sensor data and the component state.

### CROSS-REFERENCE TO RELATED APPLICATION

This application is a continuation of International PCT Application No. PCT/CN2025/122746, filed on Sep. 19, 2025, which claims priority to Chinese Patent Application No. 202510585253.8, filed with the China National Intellectual Property Administration on May 8, 2025 and entitled “METHOD AND APPARATUS FOR SIMULATING EXTERNAL TEMPERATURE OF VEHICLE, ELECTRONIC DEVICE AND VEHICLE”. The two applications are incorporated herein by reference in their entireties.

### TECHNICAL FIELD

The present application relates to the technical field of data processing, in particular, to method and apparatus for simulating an external temperature of a vehicle, an electronic device and a vehicle.

### BACKGROUND

With the continuous development of the automotive industry, an external temperature display function of vehicles has become a standard configuration for automobiles.

An external temperature can be displayed on a vehicle-mounted terminal or an instrument panel, allowing a driver to better understand a current external temperature of a vehicle. Moreover, a vehicle's controller can make adaptive adjustments to the vehicle based on the external temperature, thereby providing a more comfortable vehicle environment for the driver. Although some manufacturers install temperature sensors on the exterior of the vehicle to collect the external temperature through the temperature sensors, most of the external sensors are installed near an air intake grille of the vehicle or near left and right rearview mirrors of the vehicle. Installing temperature sensors in these positions may result in collected external temperature being inaccurate due to the influence of light or thermal radiation from a condenser or a radiator.

### SUMMARY

The first objective of the present disclosure is to provide method and apparatus for simulating an external temperature of a vehicle, an electronic device and a vehicle, so as to solve the problem in the prior art that although some manufacturers install a temperature sensor on the exterior of the vehicle, the external temperature of the vehicle cannot be accurately collected; the second objective is to provide an apparatus; the third objective is to provide an electronic device; and the fourth objective is to provide a vehicle.

To achieve the above objectives, a technical solution adopted by the present disclosure is as follows.

A method for simulating an external temperature of a vehicle is provided, where the vehicle is provided with at least one sensor and at least one part, and the method includes:
acquiring sensor data collected by the sensor and a component state of the part, where the sensor data is used to determine at least one sensor temperature of the vehicle;
acquiring a memorial external temperature of the vehicle obtained by a previous simulation;
acquiring at least one temperature range interval of the vehicle, where each temperature range interval has a corresponding processing logic;
taking a minimum value among the sensor temperatures as a target temperature;
taking a temperature range interval in which a difference between the memorial external temperature and the target temperature falls as a target temperature range interval; and
simulating the external temperature of the vehicle according to the processing logic corresponding to the target temperature range interval, the sensor data and the component state.

In an embodiment of the present disclosure, the sensor data at least includes a water temperature of an engine, a water temperature of a motor, a high-pressure pressure of a refrigerant system, a low-pressure pressure of the refrigerant system, a temperature of the refrigerant system and a vehicle speed;
the high-pressure pressure of the refrigerant system has a corresponding refrigerant temperature, and the low-pressure pressure of the refrigerant system has a corresponding refrigerant temperature;
the water temperature of the engine, the water temperature of the motor, the temperature of the refrigerant system, the refrigerant temperature corresponding to the high-pressure pressure of the refrigerant system and the refrigerant temperature corresponding to the low-pressure pressure of the refrigerant system are collectively referred to as sensor temperatures;
the component state at least includes a compressor state, a cooling fan state, and a battery cooling state;
the compressor state at least includes a rotation speed of a compressor; the cooling fan state at least includes a rotation speed of a cooling fan; the battery cooling state at least includes an activation of a battery cooling strategy and a deactivation of the battery cooling strategy.

### (Canceled)

In an embodiment of the present disclosure, the acquiring the memorial external temperature of the vehicle obtained by the previous simulation includes:
when there is no memorial external temperature of the vehicle obtained by the previous simulation, taking a minimum value among the sensor temperatures as the memorial external temperature.

### (Canceled)

In an embodiment of the present disclosure, the simulating the external temperature of the vehicle according to the processing logic corresponding to the target temperature range interval, the sensor data and the component state includes:
acquiring a rotation speed and a duration of the compressor of the vehicle;
acquiring a rotation speed threshold and a duration threshold in the processing logic corresponding to the target temperature range interval; and
simulating the external temperature of the vehicle according to the rotation speed, the duration, the rotation speed threshold, the duration threshold, the sensor data and the component state.

In an embodiment of the present disclosure, the rotation speed threshold includes a first rotation speed threshold and a second rotation speed threshold, and the first rotation speed threshold is less than the second rotation speed threshold;
the duration threshold includes a first duration threshold and a second duration threshold, and the first duration threshold is less than the second duration threshold;
where the simulating the external temperature of the vehicle according to the rotation speed, the duration, the rotation speed threshold, the duration threshold, the sensor data and the component state includes:
in a case where the rotation speed is less than the first rotation speed threshold and the duration is less than the first duration threshold, and in a case where the rotation speed is greater than the second rotation speed threshold and the duration is less than the second duration threshold, determining the target temperature as the external temperature of the vehicle;
in a case where the rotation speed is less than the first rotation speed threshold and the duration is greater than the first duration threshold, determining the external temperature of the vehicle according to the water temperature of the engine, the water temperature of the motor, the high-pressure pressure of the refrigerant system, the low-pressure pressure of the refrigerant system and a preset offset value; and
in a case where the rotation speed is greater than the second rotation speed threshold and the duration is greater than the second duration threshold, determining the external temperature of the vehicle according to the water temperature of the engine, the water temperature of the motor, the high-pressure pressure of the refrigerant system, a compensation value corresponding to the vehicle speed, a compensation value corresponding to the low-pressure pressure of the refrigerant system and a compensation value corresponding to the component state of the part.

In an embodiment of the present disclosure, the determining the external temperature of the vehicle according to the water temperature of the engine, the water temperature of the motor, the high-pressure pressure of the refrigerant system, the low-pressure pressure of the refrigerant system and the preset offset value includes:
performing averaging processing on the high-pressure pressure of the refrigerant system and the low-pressure pressure of the refrigerant system to obtain an average pressure of the refrigerant system;
determining a first candidate temperature according to a refrigerant temperature corresponding to the average pressure of the refrigerant system and the preset offset value; and
determining a minimum value among the water temperature of the engine, the water temperature of the motor and the first candidate temperature as the external temperature of the vehicle.

In an embodiment of the present disclosure, the determining the external temperature of the vehicle according to the water temperature of the engine, the water temperature of the motor, the high-pressure pressure of the refrigerant system, the compensation value corresponding to the vehicle speed, the compensation value corresponding to the low-pressure pressure of the refrigerant system and the compensation value corresponding to the component state of the part includes:
determining a second candidate temperature according to a refrigerant temperature corresponding to the high-pressure pressure of the refrigerant system, the compensation value corresponding to the vehicle speed and the compensation value corresponding to the component state of the part; and
determining a minimum value among the water temperature of the engine, the water temperature of the motor and the second candidate temperature as the external temperature of the vehicle.

In an embodiment of the present disclosure, after the simulating the external temperature of the vehicle according to the sensor data and the component state, the method further includes:
when the external temperature is different from the memorial external temperature, displaying the external temperature in accordance with a preset output limit to simulate a change trend of a real external temperature of the vehicle.

In an embodiment of the present disclosure, after the simulating the external temperature of the vehicle according to the sensor data and the component state, the method further includes:
when the sensor includes a temperature sensor installed outside the vehicle, acquiring a measured external temperature corresponding to the temperature sensor;
determining a target external temperature according to the measured external temperature and the external temperature; and
displaying the target external temperature.

An apparatus for simulating an external temperature of a vehicle is provided. The vehicle is provided with at least one sensor and at least one part, and the apparatus includes:
a data acquisition module, configured to acquire the sensor data collected by the sensor and a component state of the part, where the sensor data is used to determine at least one sensor temperature of the vehicle; and
a temperature simulation module, configured to acquire a memorial external temperature of the vehicle obtained by a previous simulation;
acquire at least one temperature range interval of the vehicle, where each temperature range interval has a corresponding processing logic;
take a minimum value among the sensor temperatures as a target temperature;
take a temperature range interval in which a difference between the memorial external temperature and the target temperature falls as a target temperature range interval; and
simulate the external temperature of the vehicle according to the processing logic corresponding to the target temperature range interval, the sensor data and the component state.

An electronic device is provided, including: a processor; and a memory for storing instructions executable by the processor;
where the processor is configured to execute the instructions to implement the aforementioned method for simulating the external temperature of the vehicle.

A computer-readable storage medium is provided. When the instructions in the storage medium are executed by a processor of a mobile terminal, the mobile terminal is enabled to execute the aforementioned method for simulating the external temperature of the vehicle.

A vehicle is provided, and the vehicle includes the aforementioned electronic device.

Beneficial effects of the present disclosure are as follows:
in the embodiments of the present disclosure, the vehicle is provided with at least one sensor and at least one part. The sensor data collected by the sensor and the component state of the part are acquired, where the at least one sensor temperature of the vehicle can be determined according to the sensor data. Then, the memorial external temperature of the vehicle obtained by a previous simulation can then be acquired, the at least one temperature range interval of the vehicle can be acquired, where each temperature range interval has a corresponding processing logic, the minimum value among the sensor temperatures is taken as the target temperature, the temperature range interval in which the difference between the memorial external temperature and the target temperature falls is taken as the target temperature range interval, and the external temperature of the vehicle is simulated according to the processing logic corresponding to the target temperature range interval, the sensor data and the component state. In a case where the vehicle is not provided with a temperature sensor or an external temperature collected by the temperature sensor is inaccurate, the embodiments of the present disclosure can use the sensor data collected by the sensor already provided on the vehicle and the component state of the part to jointly simulate an accurate external temperature of the vehicle. The accurate external temperature can be obtained without increasing the hardware cost of the vehicle, thereby providing a better vehicle environment for a driver of the vehicle based on the accurate external temperature.

### BRIEF DESCRIPTION OF THE DRAWINGS

FIG. 1 is a flow chart of steps of a method for simulating an external temperature of a vehicle provided in an embodiment of the present disclosure.

FIG. 2 is a schematic diagram of the principle of simulation of an external temperature of a vehicle provided in an embodiment of the present disclosure.

FIG. 3 is a schematic diagram of simulation of an external temperature of a vehicle based on different temperature range intervals provided in an embodiment of the present disclosure.

FIG. 4 is a structural schematic diagram of an apparatus for simulating an external temperature of a vehicle provided in an embodiment of the present disclosure.

FIG. 5 is a structural schematic diagram of an electronic device provided in an embodiment of the present disclosure.

### DESCRIPTION OF THE EMBODIMENTS

In the following, the implementations of the present disclosure will be described with reference to the accompanying drawings and embodiments. Those skilled in the art can easily understand other advantages and effects of the present disclosure from the content disclosed in this specification. The present disclosure can also be implemented or applied through other different specific implementations, and various details in this specification can also be modified or changed based on different viewpoints and applications without departing from the spirit of the present disclosure. It should be understood that the embodiments are only for illustrating the present disclosure, rather than limiting the protection scope of the present disclosure.

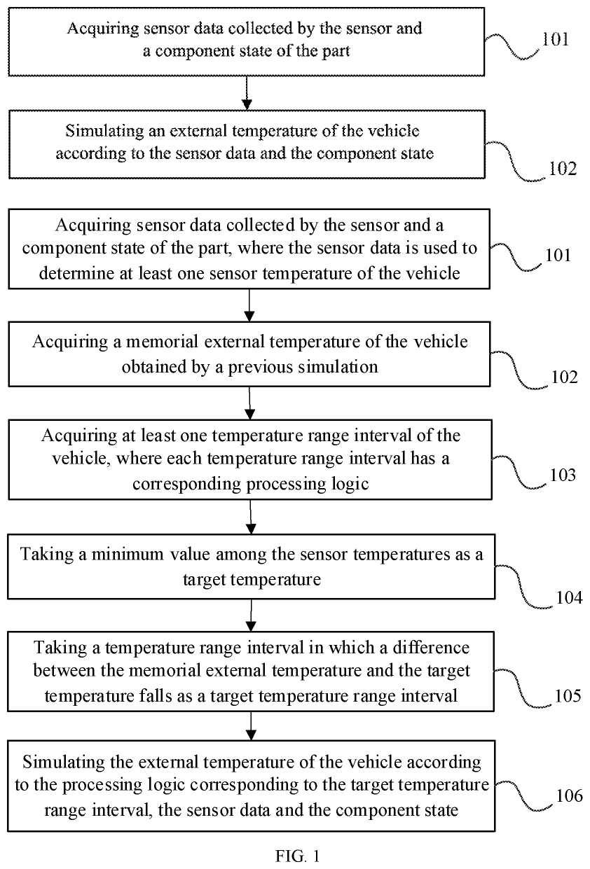

Referring to FIG. 1, a flow chart of steps of a method for simulating an external temperature of a vehicle provided in an embodiment of the present disclosure is shown. The vehicle is provided with at least one sensor and at least one part, and the method specifically includes the following steps.

Step 101: acquiring sensor data collected by the sensor and a component state of the part, where the sensor data is used to determine at least one sensor temperature of the vehicle.

In practical application, a vehicle is usually provided with at least one sensor and at least one part, and usually multiple ones. For example, the sensor may include a temperature sensor, a pressure sensor, a speed sensor, etc., and the part may include a cooling fan, a compressor, a battery, etc.

In an embodiment of the present disclosure, the sensor data collected by the sensor on the vehicle can be acquired. For example, the sensor data may at least include a water temperature of an engine, a water temperature of a motor, a high-pressure pressure of a refrigerant system, a low-pressure pressure of the refrigerant system, a temperature of the refrigerant system, a vehicle speed and other data, where the refrigerant system is a refrigeration cycle system in vehicle thermal management, and its core component may include a compressor, a condenser, an expansion valve, an evaporator, etc. It uses the phase change characteristics of refrigerants (refrigerating fluid) to absorb heat from a passenger compartment or a battery, so as to realize temperature control. The high-pressure pressure of the refrigerant system is a pressure on a high-pressure side of the refrigerants from an outlet of the compressor to the front of the expansion valve, which reflects a heat dissipation efficiency of the condenser. The low-pressure pressure of the refrigerant system is a pressure on a low-pressure side of the refrigerants from an outlet of the evaporator to an inlet of the compressor, which reflects a heat absorption capacity of the evaporator. The high-pressure pressure of the refrigerant system has a corresponding refrigerant temperature, and the low-pressure pressure of the refrigerant system has a corresponding refrigerant temperature. The temperature of the refrigerant system is a temperature of a low-temperature and low-pressure gaseous refrigerant collected by a temperature sensor installed on a low-pressure side of a refrigeration cycle (usually located at the outlet of the evaporator or a suction pipeline of the compressor). For the convenience of description, in the subsequent description, the water temperature of the engine, the water temperature of the motor, the temperature of the refrigerant system, the refrigerant temperature corresponding to the high-pressure pressure of the refrigerant system and the refrigerant temperature corresponding to the low-pressure pressure of the refrigerant system are collectively referred to as sensor temperatures.

In an embodiment of the present disclosure, the component state corresponding to the part on the vehicle can also be acquired. The component state may at least include a compressor state, a cooling fan state, and a battery cooling state; where the compressor states may at least include a rotation speed of the compressor; the cooling fan states at least includes a rotation speed of the cooling fan; the battery cooling states at least includes an activation of the battery cooling strategy and a deactivation of the battery cooling strategy. Specifically, when the battery cooling strategy is activated, components such as an electric water pump and the cooling fan on the vehicle can be started, so as to perform thermal management on the battery.

Step 102: acquiring a memorial external temperature of the vehicle obtained by a previous simulation;

Step 103: acquiring at least one temperature range interval of the vehicle, where each temperature range interval has a corresponding processing logic;

Step 104: taking a minimum value among the sensor temperatures as a target temperature;

Step 105: taking a temperature range interval in which a difference between the memorial external temperature and the target temperature falls as a target temperature range interval; and

Step 106: simulating the external temperature of the vehicle according to the processing logic corresponding to the target temperature range interval, the sensor data and the component state.

In an embodiment of the present disclosure, after the sensor data and the component state are acquired, these data can be combined to simulate and obtain the external temperature of the vehicle. Furthermore, the simulated external temperature can be displayed on a vehicle-mounted terminal of the vehicle, or the vehicle can be controlled based on the external temperature. For example, when the external temperature of the vehicle is too high, the rotation speed of the compressor of the vehicle's air conditioning system can be increased, or the rotation speed of the cooling fan can be increased, etc.

In some cases, based on considerations such as cost, some vehicles are not provided with an external temperature sensor to measure the external temperature. Alternatively, when the external temperature sensor malfunctions, the external temperature of the vehicle can be simulated jointly through the sensor data and the component state. Since the vehicle in the embodiment of the present disclosure does not require a separately installed external temperature sensor, the manufacturing cost of the entire vehicle can be reduced, and it will not be affected by factors such as the installation position of the external temperature sensor and thermal radiation of a radiator, thus ensuring the accuracy of the obtained external temperature.

### (Canceled)

### (Canceled)

In an embodiment of the present disclosure, the external temperature of the vehicle obtained by the previous simulation can be acquired as the memorial external temperature, and the external temperature of the vehicle can be simulated jointly according to the memorial external temperature, the sensor data and the component state.

In some embodiments, when there is no memorial external temperature of the vehicle obtained by the previous simulation (for example, when the simulation of the external temperature of the vehicle is started for the first time), a minimum value among the sensor temperatures can be taken as the memorial external temperature. That is, a minimum value is screened out from sensor temperatures including the water temperature of the engine, the water temperature of the motor, the temperature of the refrigerant system, the refrigerant temperature corresponding to the high-pressure pressure of the refrigerant system and the refrigerant temperature corresponding to the low-pressure pressure of the refrigerant system, as the memorial external temperature, which is used to jointly simulate the external temperature of the vehicle together with the sensor data and the component state. In the above embodiments, the external temperature of the vehicle can be jointly simulated according to the memorial external temperature, the sensor data and the component state, so that accurate external temperature of the vehicle can be obtained by simulation.

### (Canceled)

### (Canceled)

In specific implementation, at least one temperature range interval is preset for the vehicle, and each temperature range interval has a corresponding processing logic, where the processing logic may include a rotation speed threshold and a duration threshold. It should be noted that the temperature range interval can be set to multiple ones or with different values according to different vehicle types or different requirements. For example, there can be three temperature range intervals: TS1, TS2, and TS3. The embodiment of the present disclosure does not need to limit this.

In an embodiment of the present disclosure, the minimum value among the sensor temperatures can be taken as the target temperature, that is, the minimum value is screened out from sensor temperatures including the water temperature of the engine, the water temperature of the motor, the temperature of the refrigerant system temperature, the refrigerant temperature corresponding to the high-pressure pressure of the refrigerant system and the refrigerant temperature corresponding to the low-pressure pressure of the refrigerant system as the target temperature. Then, the temperature range interval in which the difference between the memorial external temperature and the target temperature falls is determined. Subsequently, the external temperature of the vehicle can be simulated jointly according to the processing logic corresponding to the target temperature range interval, the sensor data and the component state.

In the above embodiment, the external temperature of the vehicle can be simulated jointly according to the processing logic corresponding to the target temperature range interval, the sensor data and the component state, so that accurate external temperature of the vehicle can be obtained by simulation.

In the above method for simulating the external temperature of the vehicle, the vehicle is provided with at least one sensor and at least one part. The sensor data collected by the sensor and the component state of the part are acquired, where the at least one sensor temperature of the vehicle can be determined according to the sensor data. Then, the memorial external temperature of the vehicle obtained by a previous simulation can then be acquired, the at least one temperature range interval of the vehicle can be acquired, where each temperature range interval has a corresponding processing logic, the minimum value among the sensor temperatures is taken as the target temperature, the temperature range interval in which the difference between the memorial external temperature and the target temperature falls is taken as the target temperature range interval, and the external temperature of the vehicle is simulated according to the processing logic corresponding to the target temperature range interval, the sensor data and the component state. In a case where the vehicle is not provided with a temperature sensor or an external temperature collected by the temperature sensor is inaccurate, the embodiment of the present disclosure can use the sensor data collected by the sensor already provided on the vehicle and the component state of the part to jointly simulate an accurate external temperature of the vehicle. The accurate external temperature can be obtained without increasing the hardware cost of the vehicle, thereby providing a better vehicle environment for a driver of the vehicle based on the accurate external temperature.

In an embodiment of the present disclosure, the simulating the external temperature of the vehicle according to the processing logic corresponding to the target temperature range interval, the sensor data and the component state includes:
acquiring a rotation speed and a duration of the compressor of the vehicle;
acquiring a rotation speed threshold and a duration threshold in the processing logic corresponding to the target temperature range interval; and
simulating the external temperature of the vehicle according to the rotation speed, the duration, the rotation speed threshold, the duration threshold, the sensor data and the component state.

The processing logic may include the rotation speed threshold and the duration threshold.

In an embodiment of the present disclosure, after acquiring the processing logic corresponding to the target temperature range interval, a current rotation speed and the duration of the compressor of the vehicle can be obtained, and then the external temperature of the vehicle can be simulated according to the rotation speed, the duration, the rotation speed threshold, the duration threshold, the sensor data and the component state.

In the above embodiment, the external temperature of the vehicle can be simulated jointly according to the rotation speed, the duration, the rotation speed threshold, the duration threshold, the sensor data and the component state, so that accurate external temperature of the vehicle can be obtained by simulation.

In an embodiment of the present disclosure, the simulating the external temperature of the vehicle according to the rotation speed, the duration, the rotation speed threshold, the duration threshold, the sensor data and the component state includes:
in a case where the rotation speed is less than the first rotation speed threshold and the duration is less than the first duration threshold, and in a case where the rotation speed is greater than the second rotation speed threshold and the duration is less than the second duration threshold, determining the target temperature as the external temperature of the vehicle;
in a case where the rotation speed is less than the first rotation speed threshold and the duration is greater than the first duration threshold, determining the external temperature of the vehicle according to the water temperature of the engine, the water temperature of the motor, the high-pressure pressure of the refrigerant system, the low-pressure pressure of the refrigerant system and a preset offset value; and
in a case where the rotation speed is greater than the second rotation speed threshold and the duration is greater than the second duration threshold, determining the external temperature of the vehicle according to the water temperature of the engine, the water temperature of the motor, the high-pressure pressure of the refrigerant system, a compensation value corresponding to the vehicle speed, a compensation value corresponding to the low-pressure pressure of the refrigerant system and a compensation value corresponding to the component state of the part.

The rotation speed threshold may include a first rotation speed threshold R1 and a second rotation speed threshold R2, and R1 is less than R2; and the duration threshold may include a first duration threshold t1 and a second duration threshold t2, and t1 is less than t2. TS represents the simulated external temperature. TN represents the target temperature, that is, the minimum value among the sensor temperatures.

In the case where the rotation speed is less than R1 and the duration is less than t1, and in the case where the rotation speed is greater than R2 and the duration is less than t2, the target temperature can be determined as the external temperature of the vehicle, that is, TS=TN.

In the case where the rotation speed is less than R1 and the duration is greater than t1, the external temperature of the vehicle can be determined according to the water temperature of the engine, the water temperature of the motor, the high-pressure pressure of the refrigerant system, the low-pressure pressure of the refrigerant system and the preset offset value.

In some embodiments, the determining the external temperature of the vehicle according to the water temperature of the engine, the water temperature of the motor, the high-pressure pressure of the refrigerant system, the low-pressure pressure of the refrigerant system and the preset offset value includes:
performing averaging processing on the high-pressure pressure of the refrigerant system and the low-pressure pressure of the refrigerant system to obtain an average pressure of the refrigerant system;
determining a first candidate temperature according to a refrigerant temperature corresponding to the average pressure of the refrigerant system and the preset offset value; and
determining a minimum value among the water temperature of the engine, the water temperature of the motor and the first candidate temperature as the external temperature of the vehicle.

ΔT represents the preset offset value.

In practical implementations, by statistically analyzing a large number of the pressure and refrigerant temperature of the vehicle, refrigerant temperatures corresponding different pressures can be determined. In a specific embodiment, the calculation formula for the refrigerant temperature can be that:

refrigerant temperature=−0.8826*(pressure/1000)\hat{ }6+9.5671*(pressure/1000)\hat{ }5−42.015*(pressure/1000)\hat{ }4+97.152*(pressure/1000)\hat{ }3-132.32*(pressure/1000)\hat{ }2+132.92*(pressure/1000)−21.365.

The unit for the pressure is kilopascal kPa, and the unit for the temperature is Celsius °C.

In this way, after a pressure is determined, a refrigerant temperature corresponding to the pressure can be determined based on the calculation formula for the refrigerant temperature mentioned above.

In the embodiment of the present disclosure, the preset offset value is a parameter used to correct the simulated external temperature, which is a fixed parameter. In practical applications, external temperatures obtained from multiple simulations can be statistically analyzed with actual external temperatures to obtain the preset offset value. Therefore, when simulating the external temperature, the preset offset value can be used to correct the simulated external temperature, thereby improving the accuracy of the simulated external temperature. The compensation value is also a parameter used to correct the simulated external temperature, which is a dynamic parameter. In practical applications, external temperatures obtained by simulating under different vehicle speeds, low-pressure pressures of the refrigerant system and component states are analyzed with actual external temperatures to determine the compensation values obtained corresponding to different vehicle speeds, low-pressure pressures of the refrigerant system and component states. The compensation values corresponding to different vehicle speeds, low-pressure pressures of the refrigerant system and component states can be stored in a table format. Therefore, when simulating the external temperature, a compensation value corresponding to the current vehicle speed, low-pressure pressures of the refrigerant system and component state can be obtained by looking up the table, and then the simulated external temperature can be compensated based on the compensation value, thereby improving the accuracy of the simulated external temperature.

In an embodiment of the present disclosure, the average refrigerant system pressure is obtained by performing averaging processing on the high-pressure pressure and the low-pressure pressure of the refrigerant system, that is, the high-pressure pressure of the refrigerant system and the low-pressure pressure of the refrigerant system are summed up with the sum thereof being divided by 2 to obtain the average refrigerant system pressure. Then, the refrigerant temperature corresponding to the average refrigerant system pressure can be obtained. Combined with this refrigerant temperature and ΔT, the first candidate temperature is obtained, that is, a difference of the refrigerant temperature corresponding to the average refrigerant system pressure and ΔT. Then, a minimum value can be screened out from the water temperatures (the water temperature of the engine and the water temperature of the motor) and the difference of the refrigerant temperature corresponding to the average refrigerant system pressure and ΔT), which is determined as the external temperature of the vehicle.

The above calculation process can be expressed by the formula:

TS=min (water temperatures, (difference of refrigerant temperature corresponding to average refrigerant system pressure and ΔT))

In the case where the rotation speed is greater than R2 and the duration is greater than t2, the external temperature of the vehicle can be determined according to the water temperature of the engine, the water temperature of the motor, the high-pressure pressure of the refrigerant system, the compensation value corresponding to the vehicle speed, the compensation value corresponding to the low-pressure pressure of the refrigerant system and the compensation value corresponding to the component state of the part.

In some embodiments, the determining the external temperature of the vehicle according to the water temperature of the engine, the water temperature of the motor, the high-pressure pressure of the refrigerant system, the compensation value corresponding to the vehicle speed, the compensation value corresponding to the low-pressure pressure of the refrigerant system and the compensation value corresponding to the component state of the part includes:
determining a second candidate temperature according to a refrigerant temperature corresponding to the high-pressure pressure of the refrigerant system, the compensation value corresponding to the vehicle speed and the compensation value corresponding to the component state of the part; and
determining a minimum value among the water temperature of the engine, the water temperature of the motor and the second candidate temperature as the external temperature of the vehicle.

Specifically, the second candidate temperature can be determined according to the refrigerant temperature corresponding to the high-pressure pressure of the refrigerant system, the compensation value corresponding to the vehicle speed and the compensation value corresponding to the component state of the part. That is, the second candidate temperature is equal to the saturated refrigerant temperature corresponding to the high-pressure pressure+the vehicle speed compensation+the fan compensation+the rotation speed compensation+the low-pressure compensation. The compensation values are obtained through pre-statistical analysis. The compensation values corresponding to the component state of the part may include compensation values corresponding to the compressor state, the cooling fan state and the battery cooling state respectively. Then, a minimum value can be screened out from the water temperatures and (the saturated refrigerant temperature corresponding to the high-pressure pressure+the vehicle speed compensation+the fan compensation+the rotation speed compensation+the low-pressure compensation), which is determined as the external temperature of the vehicle.

The above calculation process can be expressed by the formula:

TS=min (water temperatures, saturated refrigerant temperature corresponding to high-pressure pressure+vehicle speed compensation+fan compensation+rotation speed compensation+low-pressure compensation)

For example, reference please made to the compensation values corresponding to vehicle speed and fan compensation of the following Table 1, the compensation values corresponding to compressor rotation speed compensation of Table 2, and the compensation values corresponding to low-pressure compensation of Table 3.

TABLE 1
Vehicle speed and fan compensations

| | | Compensation | Compensation |
|---|---|---|---|
| Vehicle | Fan | value (°C) | value (°C) |
| speed | speed | Battery | Battery |
| (km/h) | (%) | cooling on | cooling off |
| 0 | 0 | −10 | −9 |
| 0 | 20 | −9 | −8 |
| 0 | 40 | −8 | −7 |
| 0 | 60 | −7 | −6 |
| 0 | 80 | −5 | −4 |
| 20 | 0 | −8 | −7 |
| 20 | 20 | −7 | −6 |
| 20 | 40 | −6 | −5 |
| 20 | 60 | −5 | −4 |
| 20 | 80 | −4 | −3 |
| 40 | 0 | −7 | −6 |
| 40 | 20 | −6 | −5 |
| 40 | 40 | −5 | −4 |
| 40 | 60 | −4 | −3 |
| 40 | 80 | −3 | −2 |
| 60 | 0 | −6 | −5 |
| 60 | 20 | −5 | −4 |
| 60 | 40 | −4 | −3 |
| 60 | 60 | −3 | −2 |
| 60 | 80 | −2 | −1 |

TABLE 2
Compressor rotation speed compensation

| Compressor | Compensation | Compensation |
|---|---|---|
| rotation | value (°C) | value (°C) |
| speed | Battery | Battery |
| (rpm) | cooling on | cooling off |
| 0 | 0 | 0 |
| 1000 | −1 | 0 |
| 1500 | −1 | 0 |
| 2000 | −2 | −1.5 |
| 2500 | −2 | −2.5 |
| 3000 | −3 | −3.5 |
| 3500 | −3 | −4.5 |
| 4000 | −4 | −3 |
| 4500 | −6 | −5 |
| 5000 | −14 | −13 |
| 5500 | −19 | −18 |
| 6000 | −24 | −23 |
| 6500 | −28 | −27 |
| 7000 | −32 | −31 |

TABLE 3
Low-pressure compensation

| | Compensation | Compensation |
|---|---|---|
| Low- | value (°C) | value (°C) |
| pressure | Battery | Battery |
| (kPa) | cooling on | cooling off |
| 150 | 0 | 0 |
| 200 | 0 | 0 |
| 250 | −1 | 0 |
| 300 | −2 | −1 |
| 350 | −3 | −2 |
| 400 | −4 | −3 |
| 450 | −5 | −4 |
| 500 | −6 | −5 |
| 550 | −7 | −6 |
| 600 | −8 | −7 |

It should be noted that the above compensations are only examples. In practical applications, adaptive adjustments can be made according to actual situations or requirements, and the embodiment of the present disclosure does not need to limit this.

In the above embodiment, the external temperature of the vehicle can be simulated jointly according to the rotation speed, the duration, the first rotation speed threshold, the second rotation speed threshold, the first duration threshold, the second duration threshold, the sensor data and the component state, so that accurate external temperature of the vehicle can be obtained by simulation.

In an embodiment of the present disclosure, after the simulating the external temperature of the vehicle according to the sensor data and the component state, the method further includes:
when the external temperature is different from the memorial external temperature, displaying the external temperature in accordance with a preset output limit to simulate a change trend of a real external temperature of the vehicle.

In an embodiment of the present disclosure, when the external temperature is different from the memorial external temperature, the external temperature should be displayed on the vehicle-mounted terminal in accordance with the preset output limit to simulate the change trend of the real external temperature of the vehicle. For example, the preset output limit may be 0.1 °C/s (degrees Celsius per second). Assuming that the external temperature currently displayed on the vehicle-mounted terminal is 20.5 °C, and the currently simulated external temperature is 24 °C, then the vehicle-mounted terminal can display them sequentially as 20.6 °C, 20.7 °C, 20.8 °C and so on in accordance with a second-based rule.

In the above embodiment, when the simulated external temperature changes, the external temperature can be displayed on the vehicle-mounted terminal in accordance with the preset output limit to simulate the change trend of the real external temperature of the vehicle, which conforms to actual measurement characteristics of the external temperature sensor of the vehicle.

In an embodiment of the present disclosure, after the simulating the external temperature of the vehicle according to the sensor data and the component state, the method further includes:
when the sensor includes a temperature sensor installed outside the vehicle, acquiring a measured external temperature corresponding to the temperature sensor;
determining a target external temperature according to the measured external temperature and the external temperature; and
displaying the target external temperature.

In specific implementation, a temperature sensor can be installed outside the vehicle, and a measured external temperature can be obtained based on the measurement of the external temperature sensor. However, since most of the external sensors are installed near an air intake grille of the vehicle or near left and right rearview mirrors of the vehicle. Installing temperature sensors in these positions may result in collected external temperature being inaccurate due to the influence of light or thermal radiation from a condenser or radiator. Therefore, in the embodiment of the present disclosure, while acquiring the measured external temperature obtained by the external temperature sensor, the external temperature of the vehicle can be simulated jointly according to the sensor data and the component state of the vehicle. Then, a target external temperature can be determined by combining the measured external temperature and the simulated external temperature. For example, an average value of the measured external temperature and the simulated external temperature can be taken as the target external temperature, which is displayed to the driver on the vehicle-mounted terminal, or the vehicle environment of the vehicle can be controlled based on the target external temperature.

In the above embodiment, the target external temperature to be displayed can be determined by combining the measured external temperature collected by the external temperature sensor and the external temperature of the vehicle simulated jointly according to the sensor data and the component state of the vehicle, which ensures the accuracy of the external temperature displayed to the driver.

To enable those skilled in the art to better understand the embodiments of the present disclosure, specific examples are used for illustration below.

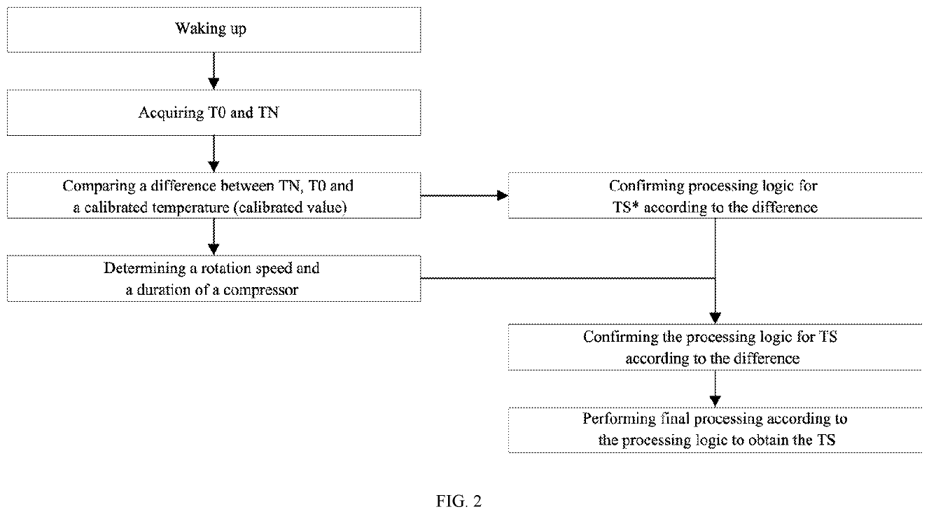

Referring to FIG. 2, it is a schematic diagram of the principle of an external temperature of the vehicle simulation disclosed in the present disclosure;

where TO represents the memorial external temperature; TN=min (the water temperature, the refrigerant temperature corresponding to the high-pressure pressure of the refrigerant system, the refrigerant temperature corresponding to the low-pressure pressure of the refrigerant system, the refrigerant system temperature); TS* represents the processing logic corresponding to the temperature range interval determined according to a difference between TO and TN, and different temperature range intervals correspond to different processing logics; TS represents a simulated value of the external temperature sensor (i.e., the simulated external temperature).

After the vehicle system is awakened, the memorial external temperature TO is acquired; a minimum value is taken as TN according to the current water temperature, the refrigerant temperature corresponding to the high-pressure pressure of the refrigerant system, the refrigerant temperature corresponding to the low-pressure pressure of the refrigerant system, and the refrigerant system temperature; by comparing the difference between TO and TN with the value of the temperature range interval, the processing logic of TS corresponding to the temperature range interval in which the difference falls is acquired, that is, TS* is obtained; the final output value TS can be obtained according to TS*. Where the temperature range intervals of TS* can be set to multiple ones according to different vehicle types or different requirements, for example, there can be temperature range intervals such as TS1, TS2, TS3, etc.

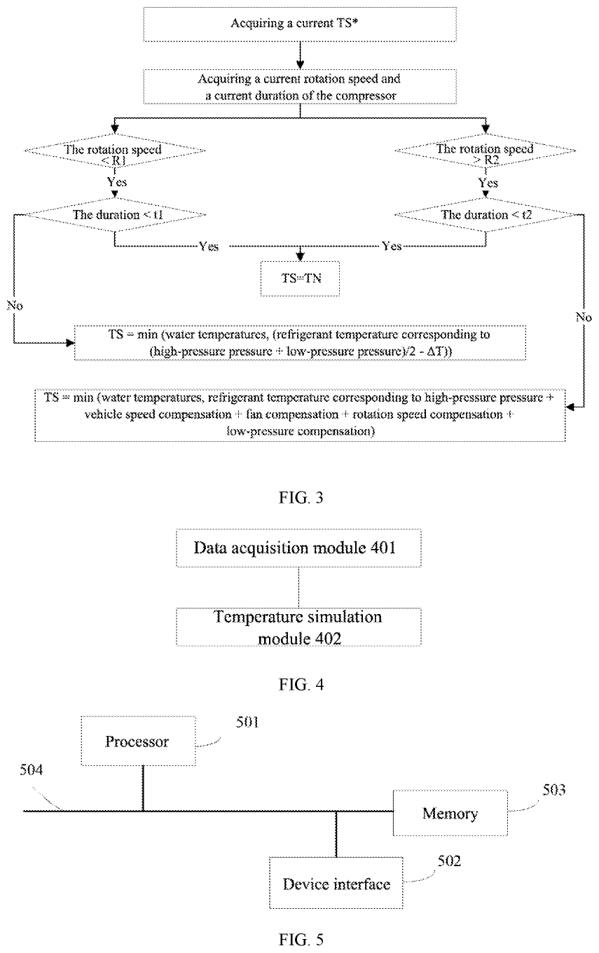

Referring to FIG. 3, it is a schematic diagram of simulation of an external temperature based on different temperature range intervals disclosed in the present disclosure. Each TS* contains different R1 (first rotation speed threshold) and R2 (second rotation speed threshold), as well as t1 (first duration threshold) and t2 (second duration threshold).

A current rotation speed and a duration of the compressor are acquired. When the rotation speed is less than R1 or the rotation speed is greater than R2, by comparing a difference between the current rotation speed of the compressor and R1 or R2, as well as a difference between the duration of the rotation speed and t1 or t2, different processing logics of TS are entered. It should be noted that when the rotation speed is greater than or equal to R1, and the rotation speed is less than or equal to R2, that is, when R1≤rotation speed≤R2, no treatment is required. Specifically:
in the case where the rotation speed is less than R1 and the duration is less than t1, and in the case where the rotation speed is greater than R2 and the duration is less than t2, TS=TN.

In the case where the rotation speed is less than R1 and the duration is greater than t1, the external temperature of the vehicle may be calculated according to the water temperature of the engine, the water temperature of the motor, the high-pressure pressure of the refrigerant system, the low-pressure pressure of the refrigerant system, and a preset offset value, that is: TS=min (the water temperature, the difference of the refrigerant temperature corresponding to the average refrigerant system pressure and ΔT)).

In the case where the rotation speed is greater than R2 and the duration is greater than t2, the external temperature of the vehicle may be calculated according to the water temperature of the engine, the water temperature of the motor, the high-pressure pressure of the refrigerant system, the compensation value corresponding to the vehicle speed, the compensation value corresponding to the low-pressure pressure of the refrigerant system, and the compensation value corresponding to the component state of the part, that is: TS=min (the water temperature, the refrigerant temperature corresponding to the high-pressure pressure+the vehicle speed compensation+the fan compensation+the rotation speed compensation+the low-pressure compensation).

In summary, the purpose of the present disclosure is to provide a method for simulating collected values of external temperature sensors. The collected value of the external temperature sensors (simulated external temperature) is simulated through sensor data of other native sensors of the vehicle and component state of executive components (part), including the joint simulation of the external temperature by the water temperature of the engine, the water temperature of the motor, high-pressure pressure of the refrigerant system, low-pressure pressure of the refrigerant system, temperature of the refrigerant system, vehicle speed, compressor states, cooling fan states, battery cooling states, etc. In practical application, the external temperature in various scenarios can be simulated jointly through the states of the above sensors and part. Each sensor and component state will compensate the simulated external temperature, making it change from a single sensor to a coupled calculation of various sensors, which is relatively more accurate and can better represent the actual external temperature.

The embodiments of the present disclosure have at least the following advantages: the embodiments of the present disclosure simulate jointly external temperature of the vehicle based on multiple sensors, and have a high fault tolerance. The vehicle does not need to be separately provided with external temperature sensors of the vehicle, which can reduce the manufacturing cost of the entire vehicle and avoid being affected by factors such as the installation position of the temperature sensors and thermal radiation of radiators. The measured external temperature collected by the external temperature sensor of the vehicle can be compensated and calculated by using the simulated external temperature, making the obtained external temperature more accurate. When the external temperature sensor of the vehicle malfunctions, it can be used as a substitute for the external temperature sensor of the vehicle to obtain the external temperature.

As shown in FIG. 4, the present disclosure discloses an apparatus for simulating an external temperature of a vehicle. The vehicle is provided with at least one sensor and at least one part, and the apparatus includes:
a data acquisition module 401, configured to acquire the sensor data collected by the sensor and a component state of the part, where the sensor data is used to determine at least one sensor temperature of the vehicle; and
a temperature simulation module 402, configured to acquire a memorial external temperature of the vehicle obtained by a previous simulation;
acquire at least one temperature range interval of the vehicle, where each temperature range interval has a corresponding processing logic;
take a minimum value among the sensor temperatures as a target temperature;
take a temperature range interval in which a difference between the memorial external temperature and the target temperature falls as a target temperature range interval; and
simulate the external temperature of the vehicle according to the processing logic corresponding to the target temperature range interval, the sensor data and the component state.

In an embodiment of the present disclosure, the sensor data at least includes a water temperature of an engine, a water temperature of a motor, a high-pressure pressure of a refrigerant system, a low-pressure pressure of the refrigerant system, a temperature of the refrigerant system and a vehicle speed;
the high-pressure pressure of the refrigerant system has a corresponding refrigerant temperature, and the low-pressure pressure of the refrigerant system has a corresponding refrigerant temperature;
the water temperature of the engine, the water temperature of the motor, the temperature of the refrigerant system, the refrigerant temperature corresponding to the high-pressure pressure of the refrigerant system and the refrigerant temperature corresponding to the low-pressure pressure of the refrigerant system are collectively referred to as sensor temperatures;
the component state at least includes a compressor state, a cooling fan state, and a battery cooling state;
the compressor state at least includes a rotation speed of a compressor; the cooling fan state at least includes a rotation speed of a cooling fan; the battery cooling state at least includes an activation of a battery cooling strategy and a deactivation of the battery cooling strategy.

### (Canceled)

In an embodiment of the present disclosure, the temperature simulation module 402 is specifically configured to:
when there is no memorial external temperature of the vehicle obtained by the previous simulation, take a minimum value among the sensor temperatures as the memorial external temperature.

### (Canceled)

In an embodiment of the present disclosure, the temperature simulation module 402 is specifically configured to:
acquire a rotation speed and a duration of the compressor of the vehicle;
acquire a rotation speed threshold and a duration threshold in the processing logic corresponding to the target temperature range interval; and
simulate the external temperature of the vehicle according to the rotation speed, the duration, the rotation speed threshold, the duration threshold, the sensor data and the component state.

In an embodiment of the present disclosure, the rotation speed threshold includes a first rotation speed threshold and a second rotation speed threshold, and the first rotation speed threshold is less than the second rotation speed threshold;
the duration threshold includes a first duration threshold and a second duration threshold, and the first duration threshold is less than the second duration threshold;
where the temperature simulation module 402 is specifically configured to:
in a case where the rotation speed is less than the first rotation speed threshold and the duration is less than the first duration threshold, and in a case where the rotation speed is greater than the second rotation speed threshold and the duration is less than the second duration threshold, determine the target temperature as the external temperature of the vehicle;
in a case where the rotation speed is less than the first rotation speed threshold and the duration is greater than the first duration threshold, determine the external temperature of the vehicle according to the water temperature of the engine, the water temperature of the motor, the high-pressure pressure of the refrigerant system, the low-pressure pressure of the refrigerant system and a preset offset value; and
in a case where the rotation speed is greater than the second rotation speed threshold and the duration is greater than the second duration threshold, determine the external temperature of the vehicle according to the water temperature of the engine, the water temperature of the motor, the high-pressure pressure of the refrigerant system, a compensation value corresponding to the vehicle speed, a compensation value corresponding to the low-pressure pressure of the refrigerant system and a compensation value corresponding to the component state of the part.

In an embodiment of the present disclosure, the temperature simulation module 402 is specifically configured to:
perform averaging processing on the high-pressure pressure of the refrigerant system and the low-pressure pressure of the refrigerant system to obtain an average pressure of the refrigerant system;
determine a first candidate temperature according to a refrigerant temperature corresponding to the average pressure of the refrigerant system and the preset offset value; and
determine a minimum value among the water temperature of the engine, the water temperature of the motor and the first candidate temperature as the external temperature of the vehicle.

In an embodiment of the present disclosure, the temperature simulation module 402 is specifically configured to:
determine a second candidate temperature according to a refrigerant temperature corresponding to the high-pressure pressure of the refrigerant system, the compensation value corresponding to the vehicle speed and the compensation value corresponding to the component state of the part; and
determine a minimum value among the water temperature of the engine, the water temperature of the motor and the second candidate temperature as the external temperature of the vehicle.

In an embodiment of the present disclosure, the apparatus further includes: a temperature change trend simulation module, configured to:
when the external temperature is different from the memorial external temperature, display the external temperature in accordance with a preset output limit to simulate a change trend of a real external temperature of the vehicle.

In an embodiment of the present disclosure, the apparatus further includes: a target external temperature generation module, configured to:
when the sensor includes a temperature sensor installed outside the vehicle, acquire a measured external temperature corresponding to the temperature sensor;
determine a target external temperature according to the measured external temperature and the external temperature; and
display the target external temperature.

In the embodiment of the present disclosure, the vehicle is provided with at least one sensor and at least one part. The sensor data collected by the sensor and the component state of the part are acquired, where the at least one sensor temperature of the vehicle can be determined according to the sensor data. Then, the memorial external temperature of the vehicle obtained by a previous simulation can then be acquired, the at least one temperature range interval of the vehicle can be acquired, where each temperature range interval has a corresponding processing logic, the minimum value among the sensor temperatures is taken as the target temperature, the temperature range interval in which the difference between the memorial external temperature and the target temperature falls is taken as the target temperature range interval, and the external temperature of the vehicle is simulated according to the processing logic corresponding to the target temperature range interval, the sensor data and the component state. In a case where the vehicle is not provided with a temperature sensor or an external temperature collected by the temperature sensor is inaccurate, the embodiment of the present disclosure can use the sensor data collected by the sensor already provided on the vehicle and the component state of the part to jointly simulate an accurate external temperature of the vehicle. The accurate external temperature can be obtained without increasing the hardware cost of the vehicle, thereby providing a better vehicle environment for a driver of the vehicle based on the accurate external temperature.

For the apparatus embodiment, since it is basically similar to the method embodiment, the description is relatively simple, and for relevant part, reference can be made to the partial explanation of the method embodiment.

In an embodiment of the present disclosure, an electronic device is further provided, as shown in FIG. 5, which includes a processor 501, a device interface 502, a memory 503 and a bus 504;
the memory 503 is configured to store computer programs;
when the processor 501, when executing the programs stored in the memory 503, is configured to implement the following steps:
acquiring sensor data collected by a sensor and a component state of a part; and
simulating an external temperature of a vehicle according to the sensor data and the component state.

The bus mentioned in the above terminal may be a Peripheral Component Interconnect (PCI) bus, or an Extended Industry Standard Architecture (EISA) bus, etc. The bus can be divided into an address bus, a data bus, a control bus, and the like. For the convenience of representation, only one thick line is used in the figure, but it does not mean that there is only one bus or one type of bus.

The memory may include a Random Access Memory (RAM), and may also include a non-volatile memory, such as at least one disk memory. In an implementation, the memory may also be at least one storage apparatus located far away from the aforementioned processor.

The above processor may be a general processor, including a Central Processing Unit (CPU), a Network Processor (NP), etc.; it may also be a Digital Signal Processing (DSP), an Application Specific Integrated Circuit (ASIC), a Field-Programmable Gate Array (FPGA), or other programmable logic devices, discrete gate or transistor logic devices, discrete hardware components.

The present disclosure also provides a storage medium. When instructions in the storage medium are executed by a processor of an electronic device, the electronic device can execute the method for simulating the external temperature of the vehicle in the aforementioned embodiments. For the device embodiment, since it is basically similar to the method embodiment, the description is relatively simple, and for relevant part, reference can be made to the partial explanation of the method embodiment.

The algorithms and displays provided herein are not inherently related to any particular computer, virtual apparatus, or other devices. According to the description above, the structure required to construct such an apparatus is obvious. In addition, the present disclosure is not directed to any specific programming language. It should be understood that various programming languages can be used to implement the content of the present disclosure described herein, and the description of specific languages above is for the purpose of disclosing the best implementation of the present disclosure.

In the specification provided herein, numerous specific details are set forth. However, it can be understood that the embodiments of the present disclosure can be practiced without these specific details. In some embodiments, well-known methods, structures, and technologies are not shown in detail so as not to obscure the understanding of this specification.

Similarly, it should be understood that, in order to simplify the present disclosure and help understand one or more aspects of the disclosure, in the above description of the exemplary embodiments of the present disclosure, various features of the present disclosure are sometimes grouped together into a single embodiment, figure, or description thereof. However, the disclosed method should not be interpreted as reflecting the intention that the claimed disclosure requires more features than those explicitly stated in each claim. More precisely, as reflected in the following claims, the inventive aspects lie in fewer than all the features of a single embodiment disclosed above. Therefore, the claims following the specific implementation are thus explicitly incorporated into this specific implementation, where each claim itself serves as a separate embodiment of the present disclosure.

Those skilled in the art can understand that the modules in the device in the embodiment can be adaptively changed and provided in one or more devices different from the embodiment. The modules or units or components in the embodiments can be combined into one module or unit or component, and in addition, they can be divided into multiple sub-modules or sub-units or sub-components. Except that at least some of such features and/or processes or units are mutually exclusive, any combination can be made to combine all the features disclosed in this specification (including the accompanying claims, abstract, and drawings) and any method or device so disclosed with all the processes or units. Unless otherwise clearly stated, each feature disclosed in this specification (including the accompanying claims, abstract, and drawings) can be replaced by an alternative feature that provides the same, equivalent, or similar purpose.

Each component embodiment of the present disclosure can be implemented in hardware, or in a software module running on one or more processors, or in a combination thereof. Those skilled in the art should understand that a microprocessor or a Digital Signal Processor (DSP) can be used in practice to implement some or all of the functions of some or all of the components in the sorting device according to the present disclosure. The present disclosure can also be implemented as a device or an apparatus program for performing part or all of the methods described herein. Such a program implementing the present disclosure can be stored on a computer-readable medium, or can be in the form of one or more signals. Such signals can be downloaded from an Internet website, provided on a carrier signal, or provided in any other form.

It should be noted that the above embodiments illustrate rather than limit the present disclosure, and those skilled in the art can design alternative embodiments without departing from the scope of the appended claims. In the claims, any reference signs placed between parentheses should not be construed as limiting the claims. The word “including” does not exclude the presence of elements or steps not listed in the claims. The word “a” or “an” preceding an element does not exclude the presence of a plurality of such elements. The present disclosure can be implemented by means of hardware including several different elements and by means of a suitably programmed computer. In the unit claims listing several apparatuses, several of these apparatuses can be embodied by the same item of hardware. The use of the words first, second, and third, etc., do not denote any order. These words can be interpreted as names.

Those skilled in the art can clearly understand that, for the convenience and conciseness of description, the specific working processes of the above devices, devices, and units can refer to the corresponding processes in the foregoing method embodiments, and will not be repeated here.

The above descriptions are only some embodiments of the present disclosure and are not intended to limit the present disclosure. Any modifications, equivalent replacements, improvements, etc., made within the spirit and principles of the present disclosure shall be included in the protection scope of the present disclosure.

The above is only a specific implementation of the present disclosure, but the protection scope of the present disclosure is not limited thereto. Any person skilled in the art can easily think of changes or replacements within the technical scope disclosed by the present disclosure, and all such changes or replacements shall be covered within the protection scope of the present disclosure. Therefore, the protection scope of the present disclosure shall be subject to the protection scope of the claims.

It should be noted that the processes related to obtaining various data in the embodiments of the present disclosure are carried out on the premise of complying with the data protection laws and policies of the corresponding countries and obtaining authorization from the owners of the corresponding apparatus.

1. A method for simulating an external temperature of a vehicle, wherein the vehicle is provided with at least one sensor and at least one part, and the method comprises:
acquiring sensor data collected by the sensor and a component state of the part, wherein the sensor data is used to determine at least one sensor temperature of the vehicle;
acquiring a memorial external temperature of the vehicle obtained by a previous simulation;
acquiring at least one temperature range interval of the vehicle, where each temperature range interval has a corresponding processing logic;
taking a minimum value among the sensor temperatures as a target temperature;
taking a temperature range interval in which a difference between the memorial external temperature and the target temperature falls as a target temperature range interval; and
simulating the external temperature of the vehicle according to the processing logic corresponding to the target temperature range interval, the sensor data and the component state.

2. The method according to claim 1, wherein the sensor data at least comprises a water temperature of an engine, a water temperature of a motor, a high-pressure pressure of a refrigerant system, a low-pressure pressure of the refrigerant system, a temperature of the refrigerant system and a vehicle speed;
the high-pressure pressure of the refrigerant system has a corresponding refrigerant temperature, and the low-pressure pressure of the refrigerant system has a corresponding refrigerant temperature;
the water temperature of the engine, the water temperature of the motor, the temperature of the refrigerant system, the refrigerant temperature corresponding to the high-pressure pressure of the refrigerant system and the refrigerant temperature corresponding to the low-pressure pressure of the refrigerant system are collectively referred to as sensor temperatures;
the component state at least comprises a compressor state, a cooling fan state, and a battery cooling state;
the compressor state at least comprises a rotation speed of a compressor; the cooling fan state at least comprises a rotation speed of a cooling fan; the battery cooling state at least comprises an activation of a battery cooling strategy and a deactivation of the battery cooling strategy.

3. (canceled)

4. The method according to claim 2, wherein the acquiring the memorial external temperature of the vehicle obtained by the previous simulation comprises:
in a case where there is no memorial external temperature of the vehicle obtained by the previous simulation, taking a minimum value among the sensor temperatures as the memorial external temperature.

5. (canceled)

6. The method according to claim 2, wherein the simulating the external temperature of the vehicle according to the processing logic corresponding to the target temperature range interval, the sensor data and the component state comprises:
acquiring a rotation speed and a duration of the compressor of the vehicle;
acquiring a rotation speed threshold and a duration threshold in the processing logic corresponding to the target temperature range interval; and
simulating the external temperature of the vehicle according to the rotation speed, the duration, the rotation speed threshold, the duration threshold, the sensor data and the component state.

7. The method according to claim 6, wherein the rotation speed threshold comprises a first rotation speed threshold and a second rotation speed threshold, and the first rotation speed threshold is less than the second rotation speed threshold;
the duration threshold comprises a first duration threshold and a second duration threshold, and the first duration threshold is less than the second duration threshold;
wherein the simulating the external temperature of the vehicle according to the rotation speed, the duration, the rotation speed threshold, the duration threshold, the sensor data and the component state comprises:
in a case where the rotation speed is less than the first rotation speed threshold and the duration is less than the first duration threshold, and in a case where the rotation speed is greater than the second rotation speed threshold and the duration is less than the second duration threshold, determining the target temperature as the external temperature of the vehicle;
in a case where the rotation speed is less than the first rotation speed threshold and the duration is greater than the first duration threshold, determining the external temperature of the vehicle according to the water temperature of the engine, the water temperature of the motor, the high-pressure pressure of the refrigerant system, the low-pressure pressure of the refrigerant system and a preset offset value; and
in a case where the rotation speed is greater than the second rotation speed threshold and the duration is greater than the second duration threshold, determining the external temperature of the vehicle according to the water temperature of the engine, the water temperature of the motor, the high-pressure pressure of the refrigerant system, a compensation value corresponding to the vehicle speed, a compensation value corresponding to the low-pressure pressure of the refrigerant system and a compensation value corresponding to the component state of the part.

8. The method according to claim 7, wherein the determining the external temperature of the vehicle according to the water temperature of the engine, the water temperature of the motor, the high-pressure pressure of the refrigerant system, the low-pressure pressure of the refrigerant system and the preset offset value comprises:
performing averaging processing on the high-pressure pressure of the refrigerant system and the low-pressure pressure of the refrigerant system to obtain an average pressure of the refrigerant system;
determining a first candidate temperature according to a refrigerant temperature in corresponding to the average pressure of the refrigerant system and the preset offset value; and
determining a minimum value among the water temperature of the engine, the water temperature of the motor and the first candidate temperature as the external temperature of the vehicle.

9. The method according to claim 7, wherein the determining the external temperature of the vehicle according to the water temperature of the engine, the water temperature of the motor, the high-pressure pressure of the refrigerant system, the compensation value corresponding to the vehicle speed, the compensation value corresponding to the low-pressure pressure of the refrigerant system and the compensation value corresponding to the component state of the part comprises:
determining a second candidate temperature according to a refrigerant temperature corresponding to the high-pressure pressure of the refrigerant system, the compensation value corresponding to the vehicle speed and the compensation value corresponding to the component state of the part; and
determining a minimum value among the water temperature of the engine, the water temperature of the motor and the second candidate temperature as the external temperature of the vehicle.

10. The method according to claim 2, further comprising:
in a case where the external temperature is different from the memorial external temperature, displaying the external temperature in accordance with a preset output limit to simulate a change trend of a real external temperature of the vehicle.

11. The method according to claim 1, further comprising:
in a case where the sensor comprises a temperature sensor installed outside the vehicle, acquiring a measured external temperature corresponding to the temperature sensor;
determining a target external temperature according to the measured external temperature and the external temperature; and
displaying the target external temperature.

12. An electronic device, comprising:
a processor; and
a memory, configured to store instructions executable by the processor;
wherein the processor, when executing the instructions, is configured to:
acquire sensor data collected by the sensor and a component state of the part, wherein the sensor data is used to determine at least one sensor temperature of the vehicle;
acquire a memorial external temperature of the vehicle obtained by a previous simulation;
acquire at least one temperature range interval of the vehicle, where each temperature range interval has a corresponding processing logic;
take a minimum value among the sensor temperatures as a target temperature;
take a temperature range interval in which a difference between the memorial external temperature and the target temperature falls as a target temperature range interval; and
simulate the external temperature of the vehicle according to the processing logic corresponding to the target temperature range interval, the sensor data and the component state.

13. The electronic device according to claim 12, wherein the sensor data at least comprises a water temperature of an engine, a water temperature of a motor, a high-pressure pressure of a refrigerant system, a low-pressure pressure of the refrigerant system, a temperature of the refrigerant system and a vehicle speed;
the high-pressure pressure of the refrigerant system has a corresponding refrigerant temperature, and the low-pressure pressure of the refrigerant system has a corresponding refrigerant temperature;
the water temperature of the engine, the water temperature of the motor, the temperature of the refrigerant system, the refrigerant temperature corresponding to the high-pressure pressure of the refrigerant system and the refrigerant temperature corresponding to the low-pressure pressure of the refrigerant system are collectively referred to as sensor temperatures;
the component state at least comprises a compressor state, a cooling fan state, and a battery cooling state;
the compressor state at least comprises a rotation speed of a compressor; the cooling fan state at least comprises a rotation speed of a cooling fan; the battery cooling state at least comprises an activation of a battery cooling strategy and a deactivation of the battery cooling strategy.

14. (canceled)

15. The electronic device according to claim 13, wherein the processor is configured to:
in a case where there is no memorial external temperature of the vehicle obtained by the previous simulation, take a minimum value among the sensor temperatures as the memorial external temperature.

16. (canceled)

17. The electronic device according to claim 13, wherein the processor is configured to:
acquire a rotation speed and a duration of the compressor of the vehicle;
acquire a rotation speed threshold and a duration threshold in the processing logic corresponding to the target temperature range interval; and
simulate the external temperature of the vehicle according to the rotation speed, the duration, the rotation speed threshold, the duration threshold, the sensor data and the component state.

18. The electronic device according to claim 17, wherein the rotation speed threshold comprises a first rotation speed threshold and a second rotation speed threshold, and the first rotation speed threshold is less than the second rotation speed threshold;
the duration threshold comprises a first duration threshold and a second duration threshold, and the first duration threshold is less than the second duration threshold;
wherein the processor is configured to:
in a case where the rotation speed is less than the first rotation speed threshold and the duration is less than the first duration threshold, and in a case where the rotation speed is greater than the second rotation speed threshold and the duration is less than the second duration threshold, determine the target temperature as the external temperature of the vehicle;
in a case where the rotation speed is less than the first rotation speed threshold and the duration is greater than the first duration threshold, determine the external temperature of the vehicle according to the water temperature of the engine, the water temperature of the motor, the high-pressure pressure of the refrigerant system, the low-pressure pressure of the refrigerant system and a preset offset value; and
in a case where the rotation speed is greater than the second rotation speed threshold and the duration is greater than the second duration threshold, determine the external temperature of the vehicle according to the water temperature of the engine, the water temperature of the motor, the high-pressure pressure of the refrigerant system, a compensation value corresponding to the vehicle speed, a compensation value corresponding to the low-pressure pressure of the refrigerant system and a compensation value corresponding to the component state of the part.

19. A non-transitory computer-readable storage medium, wherein when instructions in the storage medium are executed by a processor of a mobile terminal, the mobile terminal is enabled to execute the following operations:
acquiring sensor data collected by the sensor and a component state of the part, wherein the sensor data is used to determine at least one sensor temperature of the vehicle;
acquiring a memorial external temperature of the vehicle obtained by a previous simulation;
acquiring at least one temperature range interval of the vehicle, where each temperature range interval has a corresponding processing logic;
taking a minimum value among the sensor temperatures as a target temperature;
taking a temperature range interval in which a difference between the memorial external temperature and the target temperature falls as a target temperature range interval; and
simulating the external temperature of the vehicle according to the processing logic corresponding to the target temperature range interval, the sensor data and the component state.

20. A vehicle, comprising the electronic device according to claim 12.

21. The electronic device according to claim 18, wherein the processor is configured to:
perform averaging processing on the high-pressure pressure of the refrigerant system and the low-pressure pressure of the refrigerant system to obtain an average pressure of the refrigerant system;
determine a first candidate temperature according to a refrigerant temperature corresponding to the average pressure of the refrigerant system and the preset offset value; and
determine a minimum value among the water temperature of the engine, the water temperature of the motor and the first candidate temperature as the external temperature of the vehicle.

22. The electronic device according to claim 21, wherein the processor is configured to:
determine a second candidate temperature according to a refrigerant temperature corresponding to the high-pressure pressure of the refrigerant system, the compensation value corresponding to the vehicle speed and the compensation value corresponding to the component state of the part; and
determine a minimum value among the water temperature of the engine, the water temperature of the motor and the second candidate temperature as the external temperature of the vehicle.

23. The electronic device according to claim 13, wherein the processor is configured to:
in a case where the external temperature is different from the memorial external temperature, display the external temperature in accordance with a preset output limit to simulate a change trend of a real external temperature of the vehicle.

24. The electronic device according to claim 12, wherein the processor is configured to:
in a case where the sensor comprises a temperature sensor installed outside the vehicle, acquire a measured external temperature corresponding to the temperature sensor;
determine a target external temperature according to the measured external temperature and the external temperature; and
display the target external temperature.
